(19) United States
(12) Patent Application Publication
(10) Pub. No.: US 2010/0122165 A1
(43) Pub. Date: May 13, 2010

(54) MECHANISM FOR DISPLAYING EXTERNAL VIDEO IN PLAYBACK ENGINES

(75) Inventor: Justin Uberti, Mountain View, CA (US)

Correspondence Address: GOOGLE / FENWICK, SILICON VALLEY CENTER, 801 CALIFORNIA ST., MOUNTAIN VIEW, CA, 94041, US

(73) Assignee: Google Inc., Mountain View, CA (US)

(21) Appl. No.: 12/267,854

(22) Filed: Nov. 10, 2008

(51) Int. Cl. G06F 3/048

(52) U.S. Cl. 715/716

(57) ABSTRACT

A playback engine is enabled to display unsupported video content. In one embodiment, a virtual video camera is registered with the playback engine. The virtual video camera supports an application interface for receiving video data and a camera interface for providing video data. Video content not supported by the playback engine is processed by a component separate from the playback engine and transmitted to the virtual video camera through the application interface. The virtual video camera provides the video content to the playback engine through the camera interface.

### BACKGROUND

1. Field of Disclosure

The disclosure generally relates to the field of media processing, in particular to video data playback.

2. Description of the Related Art

There has been a recent boom in user generated and professionally created video content available over the Internet. The video content are in various video formats and are encoded using various codecs. The video content are generally displayed using playback engines. A playback engine is a software module adapted to receive video data and render it to a screen for user viewing. Playback engines are used in video player applications like Adobe Flash Player®, Apple QuickTime®, and Microsoft Windows Media Player® to display video content. Playback engines are also used in video and multimedia editors, such as Adobe Premiere®, Apple Final Cut®, and the like.

A playback engine typically only provides limited functionalities. For example, a playback engine often only supports a limited collection of codecs and video formats. Because encoded video content requires decoding before viewing, a playback engine can only properly play videos encoded using codecs which the application supports. If a video is encoded in an unsupported format, then the playback engine cannot play the video. Video services and applications may also require functionalities that are not supported by the playback engine. For example, live video conferences often require transport methods with low-delay. As another example, video hosting servers may utilize technologies such as peer-to-peer caching to enhance performance. Without such transport support, the playback engine cannot properly play the video content.

Conventionally this problem is solved by obtaining subsequent versions of the playback engines that support the needed functionalities. However, a given software provider of a playback engine may delay supporting new/additional functionalities, and sometimes choose not to support certain functionalities for business reasons. This leaves the user of the playback engine unable to use it for certain video content.

### SUMMARY

Embodiments of the present disclosure include a method (and corresponding system and computer program product) that enables a playback engine to display unsupported video content.

In one aspect of the present invention, the playback engine supports a camera interface for retrieving raw video data from physical video cameras. A virtual video camera is registered with the playback engine as a physical video camera. The virtual video camera supports an application interface for receiving video data and a camera interface for providing video data. Video content not supported by the playback engine is processed (e.g., decoded, transported) by a component separate from the playback engine and transmitted to the virtual video camera through the application interface. The virtual video camera provides the processed video content to the playback engine through the camera interface.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

FIG. 1 is a diagram illustrating a system environment for enabling a playback engine on a client device to display unsupported video streams according to one embodiment of the present disclosure.

FIG. 2 is a high-level block diagram illustrating a detailed view of modules within a client device shown in FIG. 1 according to one embodiment.

FIG. 3 is a flow diagram that illustrates a method for enabling a playback engine to playback an unsupported video stream according to one embodiment of the present disclosure.

FIG. 4 is a block diagram illustrating an example of the method shown in FIG. 3 according to one embodiment of the present invention.

### DETAILED DESCRIPTION

The present invention provides a method (and corresponding system and computer program product) for enabling a playback engine to display unsupported video content. For purpose of clarity, this description assumes that the video content is a video feed streamed from a remote computer (e.g., live broadcast feed, live video conference). Those of skill in the art will recognize that the techniques described herein can be utilized with other video content such as video files and video signals, and other media content such as audio feeds.

The Figures (FIGS.) and the following description relate to preferred embodiments by way of illustration only. Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Environment

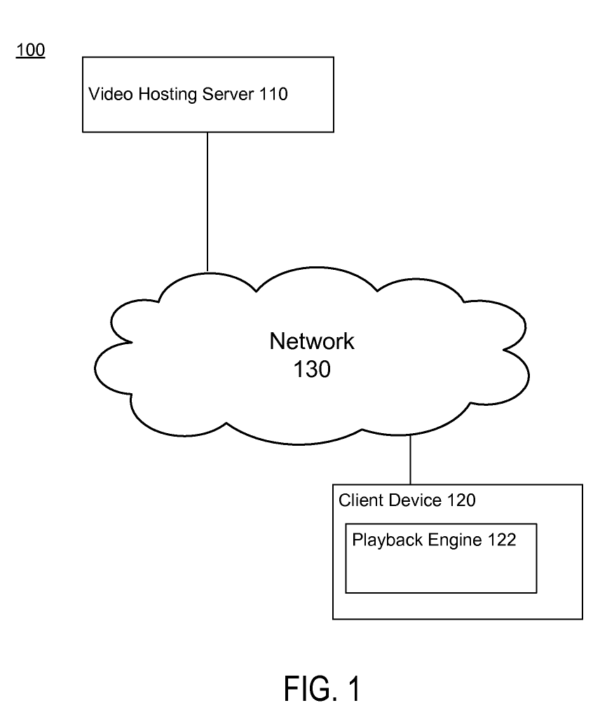

FIG. 1 is a diagram that illustrates a system environment 100 for enabling a playback engine on a client device to display unsupported video streams according to one embodiment of the present disclosure. The system environment 100 includes a video hosting server 110 and a client device 120 communicatively connected through a network 130. Only one server 110 and one client device 120 are shown in FIG. 1 for purposes of clarity, but those of skill in the art will recognize that typical system environments can have hundreds or thousands of servers 110 and millions of client devices 120. There can also be other entities connected to the network 130 beyond those shown in FIG. 1.

The video hosting server 110 is a server (or a collection of servers) configured to provide video content to the client device 120. Examples of the video hosting server 110 include video sharing websites such as YouTube™. In one embodiment, the video hosting server 110 hosts video content provided by a variety of video sources. In another embodiment, instead of or in addition to storing the video content, the video hosting server 110 provides links to video content stored elsewhere (e.g., in other video sharing websites). The video hosting server 110 provides video content to the client device 120 upon request. The video hosting server 110 also provides web pages listing the hosted video content. Users can retrieve the web pages to browse the available video, and request video content as desired (e.g., by clicking the video title/image on the web pages). The video content can be provided as video feed or video file. The video content can be provided using various transport protocols (e.g., real-time transport protocol (RTP), peer-to-peer multicast) and network technologies (e.g., peer-to-peer caching). The provided video content is encoded (e.g., by a codec) before transmission, and requires decoding before viewing or editing. The video content can be encoded as H.263, H.264, WMV, VC-1, or the like, and/or stored in any suitable container format, such as Flash, AV1, MP4, MPEG-2, RealMedia, DivX, or the like. Similarly, audio content can be encoded as MP3, AAC, or the like, and/or stored in any suitable container format.

The client device 120 is a computing device for users to retrieve video content from the video hosting server 110 through the network 130 and view the retrieved video content. Examples of the client device 120 include a personal computer (laptop or desktop), a mobile phone, a personal digital assistant (PDA), and other mobile computing devices. The client device 120 can have an operating system (e.g., Microsoft Windows, Mac OS, LINUX, or a variant of UNIX), and include a browser application (e.g., Microsoft Internet Explorer™, Mozilla Firefox™, or Apple Safari™).

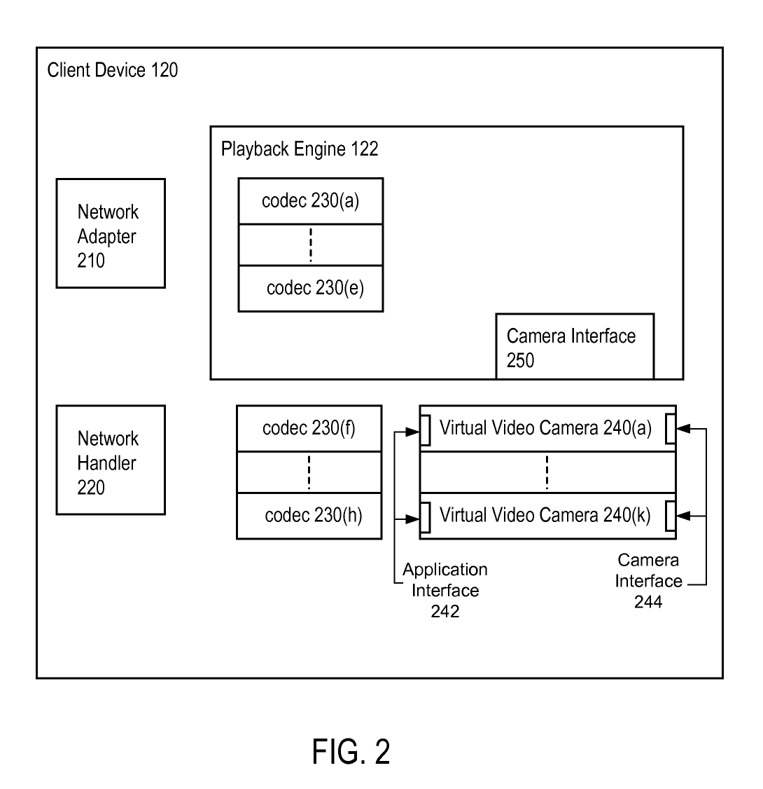

The client device 120 includes a playback engine 122 for playing video content. The playback engine 122 is a software module adapted to receive video data and render it to a screen for user viewing. The playback engine 122 can be incorporated into various types of applications, including video player applications (e.g., standalone players), multimedia capable plug-in of browser applications, multimedia editors (e.g. video editors, multimedia editors), dedicated devices (e.g., set top receivers, mobile phones), and the like. The playback engine 122 can also be a standalone application. Examples of the playback engine 122 can be incorporated into video player applications such as Adobe Flash Player, Apple QuickTime, and Microsoft Windows Media Player, as well as into video editors, such as Adobe Premiere®, Apple Final Cut®, and the like. The playback engine 122 supports one or more codecs for decoding a video stream (or video feed), file, or signal. The playback engine 122 may support a camera interface for retrieving raw video data from physical video cameras such as webcams, camcorders, or the like. The playback engine 122 may also provide programmable capabilities (e.g., specifying the source and/or identity of the video data received through the camera interface). An example architecture of the playback engine 122 will be described in further detail below with relate to FIG. 2.

The network 130 is configured to connect the video hosting server 110 and the client device 120. The network 130 may be a wired or wireless network. Examples of the network 130 include the Internet, an intranet, a WiFi network, a WiMAX network, a mobile telephone network, or a combination thereof.

### Computer Architecture

The video hosting server 110 and the client 120 shown in FIG. 1 are implemented using one or more computers. The computer includes at least one processor coupled to a chipset. The chipset includes a memory controller hub and an input/output (I/O) controller hub. A memory and a graphics adapter are coupled to the memory controller hub, and a display is coupled to the graphics adapter. A storage device, keyboard, pointing device, and network adapter are coupled to the I/O controller hub. Other embodiments of the computer have different architectures. It is expected that as more powerful computers are developed in the future, they can be configured in accordance with the teachings here.

The storage device is a computer-readable storage medium such as a hard drive, compact disk read-only memory (CD-ROM), DVD, or a solid-state memory device. The memory holds instructions and data used by the processor. The pointing device is a mouse, track ball, or other type of pointing device, and is used in combination with the keyboard to input data into the computer system. The graphics adapter displays images and other information on the display. The network adapter couples the computer system to the network 130.

The computer is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device, loaded into the memory, and executed by the processor.

The types of computers used by the entities of FIG. 1 can vary depending upon the embodiment and the processing power required by the entity. For example, a client device 120 that is a mobile telephone typically has limited processing power, a small display, and might lack a pointing device. A video hosting server 110, in contrast, might comprise multiple blade servers working together to provide the functionality described herein.

### Example Client Device Architectural Overview

FIG. 2 is a high-level block diagram illustrating a detailed view of modules within the client device 120 according to one embodiment. Some embodiments of the client device 120 have different and/or other modules than the ones described herein. Similarly, the functions can be distributed among the modules in accordance with other embodiments in a different manner than is described here. As illustrated, the client device 120 includes a network adapter 210, a network handler 220, multiple codecs 230, a playback engine 122, and one or more virtual video camera instances 240.

The network adapter 210 is a hardware device and/or software program configured to enable the client device 120 to communicate with external computing devices such as the video hosting server 110 through the network 130.

The codecs 230 are devices and/or programs capable of performing encoding and/or decoding on a video stream, file, or signal. Video streams received by the client device 120 are often encoded using certain codec, such as MPEG-4. In order for the playback engine 122 to display an encoded video stream, the encoded video stream must first be decoded using a proper codec. A codec can be configured to forward decoded video streams to modules such as virtual video camera.

The playback engine 122 is a software module configured for taking video data and rendering it to a screen for user viewing. The playback engine 122 supports one or more codecs 230 and one or more transport protocols (e.g., through a protocol handler (not shown)). For simplicity but without losing generality, it is assumed that the playback engine 122 supports codecs 230(a) through 230(e) and some transport protocols, and does not support codecs 230(f) through 230(h) and other transport protocols. The playback engine 122 is adapted to display raw (or uncompressed, unencoded) video data received from physically attached video camera devices (e.g., video cameras, camcorders, and the like). Such raw video data are received through a camera interface 250 of the playback engine 122.

A virtual video camera is a software program configured to provide video data to the playback engine 122 as a physically attached video camera (e.g., a “webcam”) through the camera interface 250. The virtual video camera presents itself as a physical video camera to the playback engine 122 and transmits decoded video content to the playback engine 122 for display. The virtual video camera can customize the playback engine 122 (e.g., utilizing its programmable capabilities) such that the playback engine 122 would not misidentify the displayed video as video from a mounted video camera. The virtual video camera can further customize the playback engine 122 to identify the source and/or identity of the video being displayed. Such information may be extracted from the received video data or otherwise received from the video source. As shown, the virtual video camera can have multiple instances 240(a) through 240(k) to process multiple video streams concurrently or sequentially. For example, a user can concurrently play multiple video feeds using the playback engine 122, each of which is handled by a separate virtual video camera instance 240. The virtual video camera can create additional instances upon demand. For example, when the virtual video camera detects a new video feed decoded by a codec 230, it invokes an additional virtual video camera instance 240 to receive the decoded video feed.

In one embodiment, each virtual video camera instance 240 supports two interfaces: an application interface 242 and a camera interface 244. The application interface 242 is configured for the virtual video camera to receive video streams from components such as the network handler 220 and the codec 230. The camera interface 244 is made available to the playback engine 122 and is configured to transmit video stream to the playback engine 122 through the camera interface 250.

The network handler 220 is a hardware device and/or software program configured to facilitate data transportation between the client device 120 and external computing devices. The network handler 220 receives data (e.g., video stream requests) from applications/modules in the client device 120, packetizes the data, and transmits the packetized data to their destinations. In addition, the network handler 220 receives data from external computing devices, depacketizes the received data, and forwards the depacketized data to their recipient applications/modules. The network handler 220 can interact (e.g., via signal exchanges) with the external computer devices to determine preferred transport protocols 235, and utilize a preferred mechanism to transmit/receive data to/from the external computer devices. For example, the network handler 220 can probe the network to establish a peer-to-peer channel for receiving requested data, or check multiple video servers to determine the lowest-latency pathway. The network handler 220 can have multiple instances, each of which handles a specific (or a specific type of) network communication. The playback engine 122 can have its own network handler (not shown), which has a protocol handler (also not shown) to process network communications using supported transport protocols.

In one embodiment, the network handler 220 is configured to decode unsupported video content and transmit the decoded video to the playback engine 122 by way of virtual video camera instance 240. As illustrated, the playback engine 122 only supports videos based on codecs 230(a)-(e) and transmitted using certain transport protocols. The playback engine 122 therefore is not configured to properly receive, decode, and/or playback videos encoded using unsupported codecs 230(f)-(h) or transmitted using unsupported transport protocols, even though those codecs are otherwise stored in the client device 120 and those transport protocols are supported by the network handler 220. The network handler 220 can be configured to probe (e.g., by sending a request) the playback engine 122 for information such as supported codec, supported transport protocols, and other supported functionalities. The network handler 220 can similarly probe the external computing devices for the underlying transport protocol and the codec 230 necessary to decode the received video feed. The network handler 220 can use the information to determine whether the received video feed is supported by the playback engine 122. The network handler 220 can be configured (e.g., through the system registry) to forward supported video feeds to the playback engine 122, and unsupported video feeds to the proper codecs 230. The proper codecs 230 and/or transport protocols can be identified based on information retrieved from the external computing devices, information extracted from the video feed, and/or codec information in the system registry of the client device 120. The codecs 230 decode the unsupported video streams into raw video data and transmit the decoded video feeds to virtual video camera instances 240(a)-(k). The virtual video camera instance 240 in turn transmits the raw video data to the playback engine 122 through the camera interfaces 244, 250. As a result, the playback engine 122 can display the video streams that are otherwise unsupported.

One of ordinary skill in the art will recognize that the client device 120 can include other components, such as a screen for displaying the video content rendered by the playback engine 122.

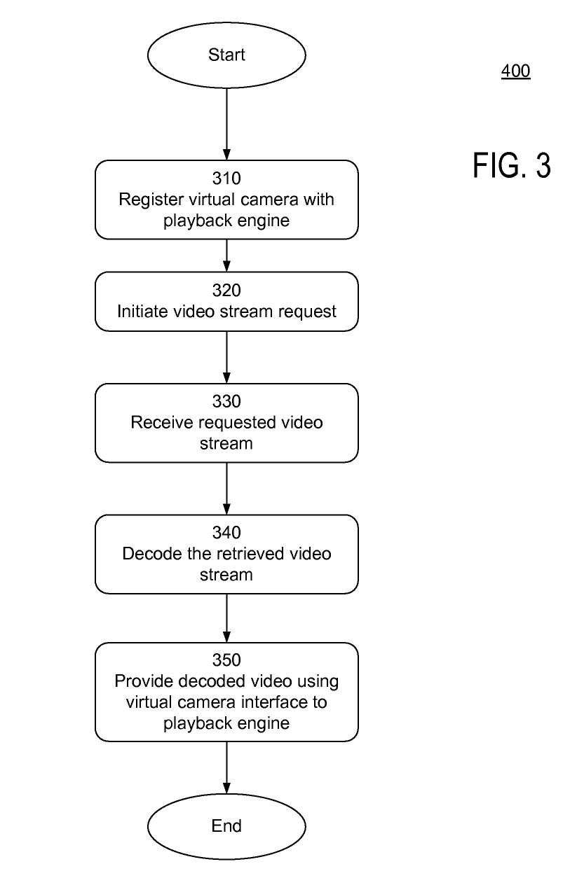

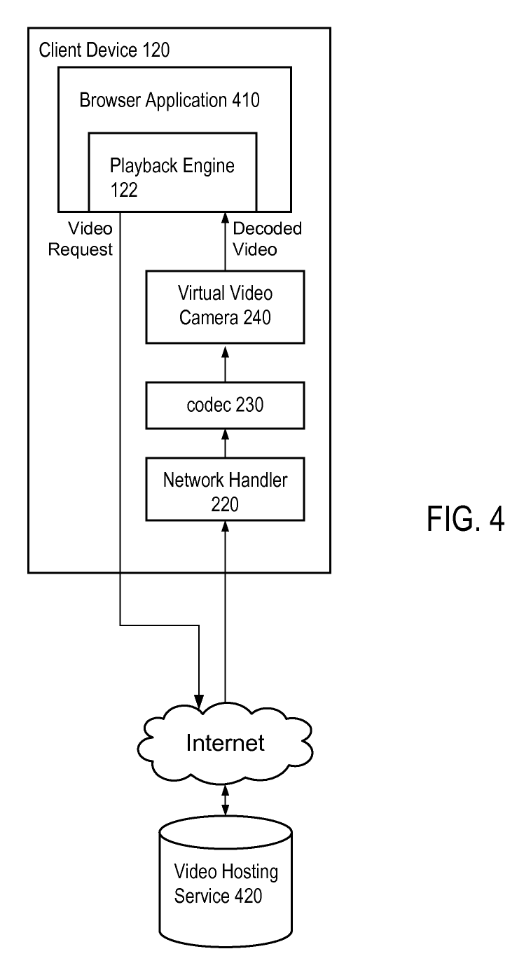

The method for the client device 120 to enable the playback engine 122 to play unsupported video streams are described in further detail below with related to FIG. 3, and illustrated by an example in FIG. 4.

### Overview of Methodology

FIG. 3 is a flowchart illustrating a method 300 for enabling the playback engine 122 to playback an unsupported video stream (or file) according to one embodiment. One or more portions of the method 300 may be implemented in embodiments of hardware and/or software or combinations thereof. For example, the method 300 may be embodied through instructions for performing the actions described herein and such instrumentations can be stored within a tangible computer readable medium (e.g., RAM, hard disk, or optical/magnetic media) and are executable by a processor (e.g., CPU). Furthermore, those of skill in the art will recognize that other embodiments can perform the steps of the method 300 in different order. Moreover, other embodiments can include different and/or additional steps than the ones described here. The client device 120 can perform multiple instances of the steps of the method 300 concurrently and/or in parallel.

As shown, the virtual video camera is registered 310 with the playback engine 122 as a physical video camera. For example, the virtual video camera registers its camera interface 244 in an operating system registry (e.g., the Microsoft Windows registry) as a camera device. By registering as a camera device, the virtual video camera presents itself to the playback engine 122 as a physical camera, and can thereinafter transmit video data to the playback engine 122 through the camera interface 250 in a manner equivalent or similar to a physical camera.

The playback engine 122 initiates 320 a video stream request. In one embodiment, the playback engine 122 generates the request based on user commands. For example, the user can request a video stream by typing in a Uniform Resource Locator (URL) of the video stream in the playback engine 122. As another example, the user can click a hyperlink of an embedded video stream in a web page or other display presentation. The playback engine 122 transmits the request to the destination computing device (e.g., the video hosting server 110) through its own network handler. It is noted that the request can be generated by applications/modules other than the playback engine 122. For example, the request can be invoked by a browser application having the playback engine 122 as a plug-in.

The network handler 220 receives 330 the requested video stream (e.g., from the video hosting server 110), depacketizes the video stream, and determines whether the playback engine 122 supports the received video stream. The network handler 220 can make the determination based on functionalities supported by the playback engine 122 (e.g., provided by the playback engine upon request) and information about the received video stream (e.g., provided by the source upon request or extracted from the stream). As described above, the playback engine 122 may not support the codec 230 for decoding the video stream, the video format, and/or the transport protocol for receiving the video stream.

If the network handler 220 determines that the playback engine 122 supports the received video stream, it forwards the video stream to the network handler of the playback engine 122. Otherwise, the network handler 220 invokes an appropriate proper codec 230 and/or protocol handler, based on the stream type, to decode 340 the video stream. The codec 230 then provides the decoded video stream to a virtual video camera instance 240 through its application interface 242. The virtual video camera instance 240 then provides 350 the decoded video stream to the playback engine 122 through the camera interfaces 244, 250.

After receiving the decoded video stream from the virtual video camera instance 240 through the camera interface 250, the playback engine 122 displays the video stream to the user as if the video stream was captured by and transmitted from a physical video camera. Therefore, the playback engine 122 is enabled to display video streams that it otherwise would not support.

### Usage Example

One exemplary usage of the present invention is illustrated by the example shown in FIG. 4. FIG. 4 is a block diagram illustrating an example process of enabling the playback engine 122 to playback an unsupported video stream according to one embodiment of the present invention. In this example, the playback engine 122 is a plug-in of a browser application, and is configured to playback video content embedded in web pages.

A user of the client device 120 accesses a video hosting service 420 using a browser application 410, and clicks on a hyperlink of a video file to request the video file. The browser application 410 (including an embedded playback engine 122) submits the request to the video hosting service 420 through the network handler of the playback engine 122 using a supported transport protocol. The video hosting service 420 returns the requested video file as a video feed to the network handler 220. The network handler 220 receives the video feed using a transport protocol and determines that the playback engine 122 does not support the necessary codec for decoding the video feed. The network handler 220 decodes the video feed using an appropriate codec, which in turn passes the decoded video feed to a virtual video camera, which in turn provides the decoded video to the playback engine 122 along with information about the source and/or the identity of the video. The playback engine 122 displays the decoded video feed along with the source and/or identity information. As a result, the user can watch the requested video file using the playback engine 122 in the web page, even though the playback engine 122 does not support the encoded video feed.

### ALTERNATIVE EMBODIMENTS

The above description is related to enabling a playback engine to display an otherwise unsupported video stream. One skilled in the art will readily recognize from the description that alternative embodiments of the disclosure may be employed to display video files (e.g., video files stored locally in a client device) and play media content such as audio, flash, game, image, to name a few.

In one alternate embodiment, the network handler can be configured to transmit all video content to the proper codecs and then to the playback engine through the virtual video camera, even if the video content is supported by the playback engine. As such the network handler, the codec, and/or the virtual video camera can be tailored to the user's needs. For example, the network handler can utilize a more advanced codec to decode video content compare to the codec the playback engine supports. The more advanced codec may be a newer version of the supported codec, a compatible codec that processes video content faster, supports higher quality, provides more features, and/or uses less system resources (e.g., memory, CPU usage). The network handler can also be configured (or implemented) to work more efficiently (e.g., faster, less resource usage) with the codec compare to the playback engine.

The above description can also be used to utilize additional functionalities that are not supported by a playback engine. For example, the playback engine may not support post-decode processing of the video such as closed-captioning. The network handler (or codec or virtual video camera) can utilize local applications or modules that support such additional functionalities to process the received video feed before transmitting the processed video feed to the playback engine for display.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for enabling a playback engine to display unsupported video streams. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A method for enabling a playback engine to display unsupported video, comprising:
registering a virtual video camera with the playback engine, the virtual video camera supporting an application interface for receiving video data;
decoding a video feed into a decoded video feed using a codec;
receiving the decoded video feed by the virtual video camera through the application interface; and
providing the decoded video feed to the playback engine by the virtual video camera through a camera interface of the playback engine.

2. The method of claim 1, wherein the codec is not supported by the playback engine.

3. The method of claim 1, further comprising:
registering a second virtual video camera with the playback engine, the second virtual video camera supporting an application interface for receiving video data;
decoding a second video feed into a second decoded video feed using a second codec;
receiving the second decoded video feed by the second virtual video camera through the application interface of the second virtual video camera, the second video feed received concurrently with the video feed; and
providing the second decoded video feed to the playback engine by the second virtual video camera through the camera interface of the playback engine, the second video feed being provided concurrently with the video feed.

4. The method of claim 3, wherein the second codec not supported by the playback engine.

5. The method of claim 1, wherein the playback engine is a web browser plug-in, and wherein the method further comprises playing back the decoded video feed by the playback engine in a web browser.

6. The method of claim 1, wherein the virtual video camera includes a camera interface, and wherein providing the video feed to the playback engine further comprises providing the video feed to the playback engine through the camera interface of the virtual video camera.

7. The method of claim 1, further comprising:
processing the decoded video feed into a processed video feed using a module independent from the playback engine; and
wherein receiving the decoded video comprises receiving the processed video feed by the virtual video camera through the application interface.

8. The method of claim 1, further comprising:
selecting the codec from a plurality of codecs, each of the plurality of codecs capable of decoding the video feed, the plurality of codes including at least a codec not supported by the playback engine.

9. A computer program product for enabling a playback engine to display unsupported video, the computer program product comprising a computer-readable medium containing computer program code for performing a method comprising:
registering a virtual video camera with the playback engine, the virtual video camera supporting an application interface for receiving video data;
decoding a video feed into a decoded video feed using a codec;
receiving the decoded video feed by the virtual video camera through the application interface; and
providing the decoded video feed to the playback engine by the virtual video camera through a camera interface of the playback engine.

10. The computer program product of claim 9, wherein the codec is not supported by the playback engine.

11. The computer program product of claim 9, wherein the method further comprises:
registering a second virtual video camera with the playback engine, the second virtual video camera supporting an application interface for receiving video data;
decoding a second video feed into a second decoded video feed using a second codec;
receiving the second decoded video feed by the second virtual video camera through the application interface of the second virtual video camera, the second video feed received concurrently with the video feed; and
providing the second decoded video feed to the playback engine by the second virtual video camera through the camera interface of the playback engine, the second video feed being provided concurrently with the video feed.

12. The computer program product of claim 11, wherein the second codec not supported by the playback engine.

13. The computer program product of claim 9, wherein the method further comprises:
playing the decoded video feed by the playback engine.

14. The computer program product of claim 9, wherein the virtual video camera includes a camera interface, and wherein providing the video feed to the playback engine further comprises providing the video feed to the playback engine through the camera interface of the virtual video camera.

15. An apparatus for enabling a playback engine to display unsupported video, the apparatus comprising:
a playback engine configured for displaying decoded video, the playback engine includes a camera interface;
a codec configured for decoding a video feed into a decoded video feed; and
a virtual video camera configured for registering with the playback engine and providing decoded video feed to the playback engine through the camera interface, the virtual video camera supporting an application interface for receiving the decoded video feed.

16. The apparatus of claim 15, wherein the codec is not supported by the playback engine.

17. The apparatus of claim 15, further comprising:
a second codec configured for decoding a second video feed into a second decoded video feed; and
a second virtual video camera configured for registering with the playback engine and providing the second decoded video feed to the playback engine through the camera interface, the second virtual video camera supporting an application interface for receiving the second decoded video feed, the second video feed received concurrently with the video feed, the second video feed being provided concurrently with the video feed.

18. The apparatus of claim 17, wherein the second codec is not supported by the playback engine.

19. A method for enabling a playback engine to display unsupported video, comprising:
registering a virtual video camera with the playback engine, the virtual video camera supporting an application interface for receiving video data;
receiving a video feed using a transport protocol not supported by the playback engine;
receiving the video feed by the virtual video camera through the application interface; and
providing the video feed to the playback engine by the virtual video camera through a camera interface of the playback engine.

20. The method of claim 19, further comprising:
selecting the transport protocol from a plurality of transport protocols, each of the plurality of transport protocols capable of receiving the video feed, the plurality of transport protocols including at least a transport protocol not supported by the playback engine.

21. A computer program product for enabling a playback engine to display unsupported video, the computer program product comprising a computer-readable medium containing computer program code for performing a method comprising:
registering a virtual video camera with the playback engine, the virtual video camera supporting an application interface for receiving video data;
receiving a video feed using a transport protocol not supported by the playback engine;
receiving the video feed by the virtual video camera through the application interface; and
providing the video feed to the playback engine by the virtual video camera through a camera interface of the playback engine.

22. The computer program product of claim 21, wherein the method further comprises:
selecting the transport protocol from a plurality of transport protocols, each of the plurality of transport protocols capable of receiving the video feed, the plurality of transport protocols including at least a transport protocol not supported by the playback engine.

23. An apparatus for enabling a playback engine to display unsupported video, the apparatus comprising:
a playback engine configured for displaying decoded video, the playback engine includes a camera interface;
a network handler for receiving a video feed using a transport protocol not supported by the playback engine; and
a virtual video camera configured for registering with the playback engine and providing video feed to the playback engine through the camera interface, the virtual video camera supporting an application interface for receiving the video feed.

24. The apparatus of claim 23, wherein the network handler is further configured for selecting the transport protocol from a plurality of transport protocols, each of the plurality of transport protocols capable of receiving the video feed, the plurality of transport protocols including at least a transport protocol not supported by the playback engine.
